(19) United States
(12) Patent Application Publication
(10) Pub. No.: US 2017/0017905 A1
(43) Pub. Date: Jan. 19, 2017

(54) CHECK-IN DEVICE AND METHOD FOR PERFORMING CHECK-INS FOR A COMPETITIVE EVENT

(71) Applicants: Robert Thomas Boyer, Longmont, CO (US); Glen Edward Boyer, Paso Robles, CA (US)

(72) Inventors: Robert Thomas Boyer, Longmont, CO (US); Glen Edward Boyer, Paso Robles, CA (US)

(21) Appl. No.: 14/800,766

(22) Filed: Jul. 16, 2015

(51) Int. Cl. G06Q 10/02

(52) U.S. Cl. CPC G06Q 10/02

(57) ABSTRACT

A check-in device configured to perform check-ins for a competitive event is provided. The cheek-in device includes a scanner configured to scan a check-in pass of a participant and generate scan data for the participant, and a processing system configured to determine the participant's identity using the scan data, determine completed check-in actions and uncompleted check-in actions corresponding to the participant's identity, and indicate further actions for the participant to complete if any uncompleted check-in action or actions remain.

### TECHNICAL FIELD

The disclosure relates generally to a method and a system for providing efficient event check-in of individual competitors, coaches, and related persons for large sporting events, and more particularly, to techniques for eliminating the long check-in lines found at a large martial arts events.

### BACKGROUND

Sporting events composed of many individual competitors have established check-in processes, sometimes called the event registration process, which often involve finding the participant in the computer system, verifying their identification, proof of citizenship, proof of residency, signing liability waivers, finding the participant's badge, and more. With hundreds or thousands of competitors, as are frequently found at state or national championships, the process typically results in check-in queues for coaches, competitors, parents, and family that may cause wait times of multiple (e.g., five+) hours for the persons in the queue.

Unlike other types of events, the check-in cannot be self-service because to properly manage the event and various competitor brackets, it is usually necessary to have tight controls on check-in and weigh-in. The queues are usually based solely on a first come, first served basis. Sometimes special lines might be provided for coaches. Depending on the tournament venue, participants may be made to wait in tight quarters or outside in the hot sun. Facilities and other refreshments may be relatively remote, inaccessible, or closed, making enduring the long queues, with a family with small children in tow, a make-or-break decision for ever returning to such a tournament.

For large events, the check-in process usually starts the day prior to the actual competition. Competitors and their families may take an extra day off work, or leave work early in order to check-in during the allotted time. For state or national events, long road trips or air flight scheduling come into play. However, the first come, first served queuing model only rewards those who are able take off more time, or schedule earlier flights, come from near and not far, or otherwise devise a way to arrive early. For everyone else, it is a test of endurance.

### BRIEF DESCRIPTION OF THE DRAWINGS

FIG. 1 shows a check-in device in one example.

FIG. 2 is a flowchart of a competitive event check-in method.

FIG. 3 shows a check-in device in another example.

FIG. 4 is a flowchart of a competitive event check-in method.

FIG. 5 shows a check-in pass in one example.

FIG. 6 shows a second side of the check-in pass.

FIG. 7 shows a sample single-function activity code that can be displayed at a competitive event and comprises a portion or step of a check-in process.

FIG. 8 shows an administrative user validation request that is presented to an

administrative user, such as event staff or event registration staff, for example.

FIG. 9 shows a sample staff credential.

FIG. 10 shows a participant codes scanning request.

FIG. 11 shows a sample single-function document check activity code.

FIG. 12 shows a general flow control for a single-activity function.

### DETAILED DESCRIPTION

One or more specific embodiments of the present techniques will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The transitional term “comprising”, which is synonymous with “including,” or “containing,” is inclusive or open-ended and does not exclude additional, unspecified elements or method steps.

Embodiments of the disclosure relate to technologies that facilitate creating efficiencies in the check-in process, sometimes called the registration process, at large sporting events with many individual competitors. Aspects of embodiments include mobile computing devices which scan participant biometrics or a check-in pass to instantly identity the participant. Embodiments include receiving, from a database, one or more values corresponding to the participant.

Based on the participant, the system determines which check-in requirements have been completed and which check-in requirements remain uncompleted. This system determines the most efficient routing within the given event's check-in environment for the participant to complete the remaining requirements. This may include sending the competitor to a photo, printing, badging, weigh-in, or other area, or lines for any such area. In some embodiments, the check-in device may support directly completing the requirements on the spot. In some embodiments, the device may be communicatively linked to a scale, such that the competitor weight is directly linked to the competitor identity, with far less potential for human error. In other embodiments, competitor biometrics may be scanned and recorded where identification is verified while later the biometrics are scanned and verified at a weigh-in station.

Certain embodiments of the present disclosure may include some, all, or none of the above advantages. One or more other technical advantages may be readily apparent to those skilled in the art from the figures, descriptions, and claims included herein. Moreover, while specific advantages have been enumerated above, various embodiments may include all, some, or none of the enumerated advantages.

A check-in device and method to reduce the wait times for event check-in are provided herein. In one embodiment of the system according to the disclosure, the system includes a computer readable storage medium having stored therein a plurality of participant information, each participant's information based on data input either online or indirectly through phone calls, email, or facsimile to an event facilitator who manually enters the data. The system also includes a computing device, coupled to the computer readable storage medium, that is configured to acquire at least some of the participant information, and further includes a user interface, coupled to the computer readable storage medium, that is configured to (a) scan a check-in pass or biometric data from a participant and generate scan data for the participant, (b) use the scan data to determine the participant's identity, (c) determine completed check-in actions and uncompleted check-in actions corresponding to the participant's identity, (d) indicate further actions for the participant to complete if any uncompleted check-in action or actions remain, (e) generate and present check-in routing to expedite performance of the uncompleted check-in actions, and (f) receive user inputs to perform some, none, or all of the uncompleted check-in actions.

One or more event representatives identify the requirements to complete an event registration. Such requirements might include identifying specific sub-events in which a competitor will participate, fees to be paid, and documents or other evidence of identity or eligibility to be provided. Said requirements may be achieved through online interaction with the system, from sub-event identification, to paying event fees, to uploading documents for verification.

The system accepts and stores basic participant (aka user) information and associates a unique identifier to the participant, much like any membership website.

The system allows the user to upload documents in a plurality of formats, e.g., images, text, etc. Three sets of attributes are associated with the uploaded document: a) user editable attributes, including as title and description; b) system generated attributes, including date and time uploaded; and c) review attributes that the user may not edit, but which may be altered by event personnel, such as content type/meaning, content valid thru, content reviewed data, and content reviewed by.

The system notifies the appropriate event representative(s) of the existence of new or un-reviewed user content and allows the event representative to review the user content and modify the review attributes. For example, to verify the user photo, one might simply preview it to make sure it is a valid representation of a person (and not a pet, landscape, or other non-person image).

A participant who completes all the requirements in advance of some specified date, such as the close of registration, is said to have completed their “homework”. Having performed this work in advance reduces the “day-of” effort, which in turn speeds the overall lines, for everyone.

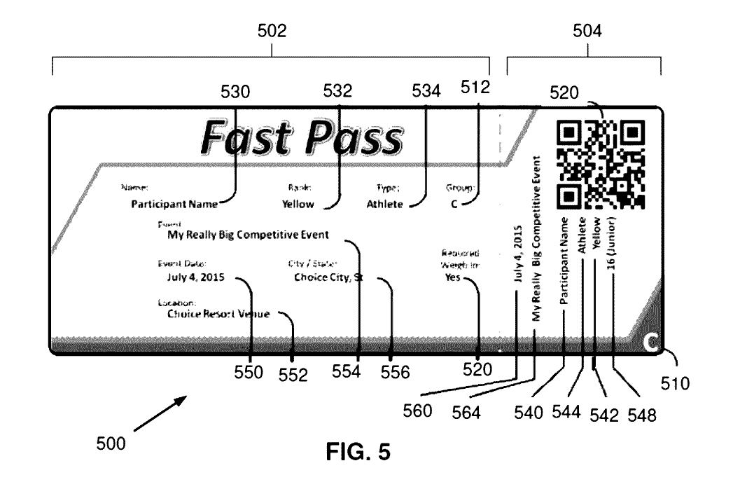

Despite the collective value of completing such work in advance, prior to this invention there has been no reward mechanism, and hence, little compliance. The novelty occurs in the ability to reward this “good behavior”. The reward is to provide a “fast pass” FIG. 5, in the form of a check-in pass 500 and separate check-in line(s) for “fast pass” ticket holders. In an alternative embodiment, an actual document for pass need not be used and a separate check-in line is provided for those who have completed their pre-requisites. In another embodiment, a physical document is obviated by scanning the participant's biometric data.

In one embodiment, a fast pass is provided only to participants who have completed all of their preparations. In another embodiment, the fast pass is annotated, e.g., with a letter, to indicate the level of compliance by the participant or another indicator to improve processing. For example:
A—participant completed all their pre-requisites and only needs to receive the credentials
B—participant has not completed all their work, but has paid
C—participant is a coach (and goes to special coach processing)
D—participant has not paid, and needs to complete payment (and may or may not have completed other pre-requisites.

In one embodiment, the participants in the fast pass line are checked-in in preference to all other participants. In another embodiment, the participants in the fast pass line are checked-in at a multiple rate of the other participants (e.g., at a 4:1 ratio). In another embodiment, the participants in the last pass line are kept distinct from the other participants, each queue moving at its own pace.

In one embodiment, the fast pass is emailed to the participant, e.g., as an email attachment. In another embodiment, a notification of “fast pass” success is emailed, with a web link (URL) provided in the email where the fast pass may be retrieved. In yet another embodiment, the time and place to retrieve and print one's fast pass is well publicized, e.g., within the system or event documentation, and participants ‘know’ to go there to pick up their pass. In yet another embodiment, the fast pass is skipped entirely, allowing the participants to print their credentials (aka badge) directly, instead of the fast pass.

The primary limitation of traditional check-in systems is the physical space available to perform the function (and not a limitation of manpower). Even for large events, the available space for check-in might be limited to two or three tables (with two stations per table). This limitation is overcome using a “cafeteria line” approach. However, rather than having the participants move through a static facility performing one task/function at each station, the stations are mobile, coming to the participants as they stand in line.

The system achieves this mobile cafeteria line by providing for a series of single functions available to administrative event personnel on their mobile devices, e.g., smart phone, tablet, etc.

Rather than the typing interaction frequently used at a normal check-in station, here the mobile device is equipped with a QR Code Reader app that was previously downloaded (usually for free). An admin user scans the QR Code printed on the participant's pass and the activity unfolds requiring only a few presses or button clicks on the touch screen.

The process can be performed or prepared in advance, with the system having encoded QR Codes and a series of potential functions which the admin user may perform. The admin user performs a short series of actions which are communicated to the server which maintains the user's check-in and other state information. The entry points to all functions are identical, i.e., use the same URL, with a parameter of the participant's unique identifier encoded into the QR Code, but the system state is used to determine which functionality is to be performed for or on that participant. In other embodiments, the QR code may contain more information or less, e.g., only the user identifier. In another embodiment, barcodes are used instead of QR Codes. In yet another embodiment RF ID tags and associated readers can be used. Any suitable, unique identification of an individual may be applied.

In some QR Code readers, the admin user is taken directly to an embedded browser functionality. In others, the user must explicitly state the intent to go to the desired web page. In some, the user must hit a “back” or “next” button or equivalent in the QR Code reader app, while in others the user must use the handheld device to instantiate another instance of the reader. These are artifacts of the QR Code reader embodiments and do not affect the essential processing logic.

In the preferred embodiment, the functions are achieved as follows. The admin user scans the QR Code that identifies the function to perform, to which the system responds with a request for the user to identify himself. The admin user then scans the QR Code on their own badge, to which the system check the database to determine if the admin user has the rights to perform the desired action. On failure, the system, takes the user to an appropriate failure page. If successful, the admin user is requested to start scanning participants to perform the desired functionality. The admin user then scans a participant's QR Code and interacts appropriately. In the preferred embodiment, the three steps described above ate used. However, the process can consist of more or less steps.

For example, for a Document Check, the admin user scans the code for the Document Check function and then confirms his right to use the function. The admin user would be presented with the complete list of pre-requisite documents or other activities and display a checkbox adjacent to each. Ones which have been completed display a green check, while the missing items show empty checkboxes. The admin user then verifies each of the missing documents, checking the appropriate checkbox as the document is verified. Upon completion, the admin user presses the submit button and the information is saved. Now the participant may proceed to the badging area to receive their badge (in the preferred embodiment, in their same line).

Functions may include information function, quick check-in, document check, standard check-in, weigh-in, event staging, awards recording, participant schedule, etc.

Additionally, with the prevalence of smart phones, iPods, iPads and other hand-held electronic devices, nearly every family who can afford to attend such events has one or more such hand-held devices. They too can download their own free QR Code reader and scan their own badge. In this case, the information function is activated providing information about the participant and their scheduled events.

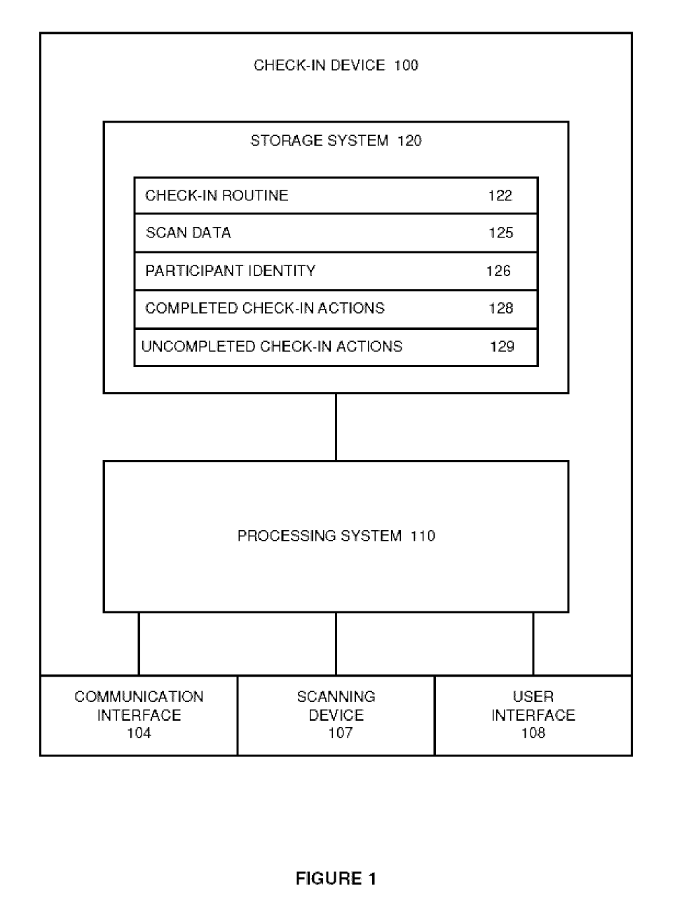

FIG. 1 shows a check-in device 100 in one example. The check-in device 100 comprises a computerized device. The check-in device 100 comprises a portable check-in device 100 in some examples. The check-in device 100 comprises a wireless check-in device 100 in some examples. The check-in device 100 includes a communication interface 104, a scanning device 107, a user interface 108, a storage system 120, and a processing system 110. The processing system 110 is coupled to the communication interface 104, the scanning device 107, the user interlace 108, and the storage system 120.

The check-in device 100 can comprise a mobile device, including a cellular phone, but also may include other devices, such as subscriber equipment, customer equipment, an access terminal, a smartphone, a telephone, a mobile wireless telephone, a personal digital assistant (PDA), a computer, an e-book, a mobile Internet appliance, a wireless network interface card, a media player, a game console, or some other communication apparatus, including combinations thereof. The check-in device 100 may be integrated within other systems and devices, such as competitive event devices, networks, or systems, or cars be integrated within vehicles, appliances, apparel, and the like.

The check-in device 100 can provide competitive event check-in services including verification of participant identity, provision of a list of completed check-in actions for a participant, and provision of a list of uncompleted check-in actions for the participant. The check-in device 100 can also perform some, none, or all of the uncompleted check-in actions, including receiving and verifying additional documentation provided by the participant, accepting payment from the participant, and generating and displaying a check-in routing to expedite performance of the uncompleted check-in actions. The displaying can comprise displaying (or otherwise outputting) the check-in routing to a competitive event worker and/or to the participant.

The communication interface 104 is configured to exchange communications between the check-in device 100 and external devices, communication networks,, and/or other systems. The communication interlace 104 sends and receives data and/or messages. The communication interface 104 in some examples is configured to communicate with competitive event devices, networks, or systems. The communication interface 104 in some examples is configured to communicate with external data storages, such as one or more data storage devices or systems storing competitive event data.

The communication interface 104 in some examples wirelessly exchanges communications. Alternatively, or in addition, the communication interface 104 exchanges communications over a communication medium, including wires, cables, fibers, or other suitable communication medium.

The communication interface 104 comprises communication components, such as ports, signal processing circuitry, memory, software, and the like. The communication interface 104 in the examples comprises a network card, network interface, port, or interface circuitry that allows the cheek-in device 100 to communicate with other devices or systems over a variety of networks. The communication interface 104 may also include a memory device, software, processing circuitry, or some other device. The communication interface 104 may use various communication protocols to exchange communications.

The communication interface 104 transfers some or all of the scan date 125 and the participant identity 126 to a competitive event device, network, or system for retrieving check-in information corresponding to the scan data 125 and the participant identity 126. Consequently, the communication interlace 104 receives the completed check-in actions 128 and the uncompleted check-in actions 129 from the competitive event device, network, or system.

The scanning device 107 comprises a device or devices for scanning graphically-presented information and generating the scan data 125. The scanning device 107 in some examples comprises an optical scanner. Alternatively, or in addition, the scanning device 107 can comprise a magnetic scanner, a radio frequency (RF) scanner that scans a RFID tag, or other suitable scanning device. The scan data 125 can include data such as a competitive event identifier, a competitive event sponsor identifier, one or more items of competitive event information, such as a location, competitive event type, a participant's class, weight, skill level, or similar information, a participant identity, and/or one or more items of information related to the participant identity.

The scanning device 107 in some examples comprises a one-dimensional scanning device. The scanning device 107 in some examples comprises a barcode reader that scans a barcode and generates the resulting scan data 125.

The scanning device 107 in some examples comprises a two-dimensional scanning device. The scanning device 107 in some examples comprises quick response (QR) code reader that scans a QR code (see the scannable code 520 of FIG. 5) and generates the resulting scan data 125.

The user interface 108 comprises one or both of user input devices and user output devices. The user interface 108 in some examples comprises one or more input devices for receiving user inputs, including keyboards, pointing devices, touch screens or touch sensors, audio inputs, or other input receiving/generating devices. The user interface 108 receives user inputs to generate or modify the scan data 125 and/or the participant Identity 126. The user interface 108 can alternatively or additionally receive user inputs to generate and display the completed check-in actions 128 and the uncompleted check-in actions 129.

The user interface 108 in some examples includes one or more output devices, including displays, touch screens, printers, speakers, or other output generating devices. The one or more output devices output information to a user or users of the cheek-in device 100, including communicating the completed check-in actions 128 and/or the uncompleted check-in actions 129, for example.

The processing system 110 comprises one or more microprocessors and other circuitry that retrieves and executes the check-in routine 122. The processing system 110 in some examples comprises circuit boards, integrated circuitry, and associated electronics. The processing system 110 can be implemented within a single processing device but can also be distributed across multiple processing devices or sub-systems that cooperate in executing program instructions. Examples of the processing system 110 include general purpose central processing units, application specific processors, and logic devices, as well as any other type of processing device, combinations, or variations thereof. In some examples, the processing system 110 includes a computer readable storage media capable of storing the check-in routine 122. The processing system 110 can include volatile and nonvolatile, removable and non-removable media implemented in any method or technology for storage of information, such as computer readable instructions, data structures, program modules, or other data.

In addition to storage media, in the examples the processing system 110 can also include communication media over which the check-in routine 122 can be communicated. The processing system 110 can be implemented to include a single storage device but can also be implemented to include multiple storage devices or sub-systems co-located or distributed relative to each other. The processing system 110 can comprise additional elements, such as a controller, capable of communicating with the storage media. Examples of storage media include random access memory, read only memory, magnetic disks, optical disks, flash memory, virtual memory and non-virtual memory, magnetic cassettes, magnetic tape, magnetic disk storage or other magnetic storage devices, or any other medium which can be used to store the desired information and that can be accessed by an instruction execution system, as well as any combination or variation thereof, or any other type of storage media. In no case is the storage media a propagated signal.

The storage system 120 comprises non-transitory, machine-readable, data storage media, such as flash drives, disc drives, memory circuitry, servers, and the like. The storage system 120 stores the check-in routine 122, the scan data 125, the participant identity 126, the completed check-in actions 128, and the uncompleted check-in actions 129, for example. The check-in routine 122 comprises machine-readable instructions that control the operation of the processing system 110 when executed. The check-in routine 122 may also include operating systems, applications, utilities, databases, and the like. All or portions of the check-in routine 122 (and other data) may be externally stored on one or more storage media, such as flash drives, discs, servers, and the like.

The cheek-in routine 122 in the examples comprises computer programs, firmware, or some other form of machine-readable processing instructions. The check-in routine 122 may include an operating system, utilities, drivers, network interfaces, applications, virtual machines, or some other type of software. The check-in routine 122 can include additional processes, programs, or components, such as operating system software, database software, or application software. The check-in routine 122 can also comprise firmware or some other form of machine-readable processing instructions executable by the processing system 110.

The scan data 125 comprises data generated by the scanning device 107. The scan data 125 comprises data generated by scanning a check-in pass 500 of a participant. The scan data 125 in some examples comprises one-dimensional scan data or two-dimensional scan data, as previously discussed.

The participant identity 126 comprises information comprising the identity of the participant. The participant identity 126 can be generated from the scan data 125 in some examples. The participant identity 126 can comprise identity data received from an external source in response to the check-in device 100 transmitting the scan data 125 to the external source for identification of the participant. The external source in some examples comprises a competitive event device, network, or system, including a competitive event server and/or a competitive event database, for example.

The completed cheek-in actions 128 comprise one or more check-in items already completed by the participant as denoted by the participant identity 126. The completed check-in actions 128 can comprise data received from the external source in response to the check-in device 100 transmitting the scan, data 125 to the external source. The completed check-in actions 128 and the uncompleted check-in actions 129 in some examples are associated with the participant identity 126.

The uncompleted check-in actions 129 comprise one or more check-in items that have not been completed by the participant as denoted by the participant identity 126. The uncompleted check-in actions 129 comprise check-in actions that need to be performed by the participant before check-in is complete for the participant. The uncompleted check-in actions 129 can comprise data received from the external source in response to the check-in device 100 transmitting the scan data 125 to the external source.

When executed by the processing system 110, the check-in routine 122 directs the check-in device 100 to scan a check-in pass 500 of a participant and generate scan data 125 for the participant, determine the participant identity 126 using the scan data 125, determine completed check-in actions 128 and uncompleted check-in actions 129 corresponding to the participant identity 126, and indicate further actions for the participant to complete if any uncompleted check-in action or actions 129 remain.

In some embodiments, the processing system 110 is further configured to generate and present a check-in routing 337 based on the uncompleted check-in actions 329 to expedite performance of the uncompleted check-in actions 329.

In some embodiments, the processing system 110 is further configured to receive user inputs 331 to perform some, none, or all of the uncompleted check-in actions 329.

In some embodiments, the processing system 110 is further configured to generate and present an expedited check-in routing 337 based on the completed check-in actions 328, wherein the check-in pass 500 of the participant includes expedited routing in advance of the competitive event based on a level of completion of check-in actions.

In some embodiments, the check-in device 300 further comprises a communication interface 304 configured to communicate with one or more external networks or systems, with the processing system 110 determining the participant's identity 326 from the scan data 325 by consulting an external data storage using the communication interface 304 and with the processing system 110 determining one or both of the completed check-in actions 328 and the uncompleted check-in actions 329 by consulting an external data storage using the communication interface 304.

In some embodiments, the processing system 110 is further configured to determine pre-event preparation of the participant based on stored participant information and generate an annotated check-in pass for the participant based on the pre-event preparation.

In some embodiments, the processing system 110 is further configured to determine pre-event preparation of the participant based on stored participant information, wherein the pre-event preparation criterion comprises one or more of verified document uploads, a pre-payment level, or a participant rank.

In general the cheek-in routine 122 can, when loaded into the processing system 110 and executed, transform the processing system 110 info a special-purpose computing system. Encoding the check-in routine 122 on the processing system 110 can transform the physical structure of the processing system 110. The specific transformation of the physical structure can depend on various factors in different implementations of this description. Examples of such factors can include, but are not limited to the technology used to implement the storage media of the processing system 110 and whether the computer-storage media are characterized as primary or secondary storage. For example, if the computer-storage media are implemented as semiconductor-based memory, the check-in routine 122 can transform the physical state of the semiconductor memory when the program is encoded therein. For example, the check-in routine 122 can transform the state of transistors, capacitors, or other discrete circuit elements constituting the semiconductor memory. A similar transformation can occur with respect to magnetic or optical media. Other transformations of physical media are possible without departing from the scope of the present description, with the foregoing examples provided only to facilitate this discussion.

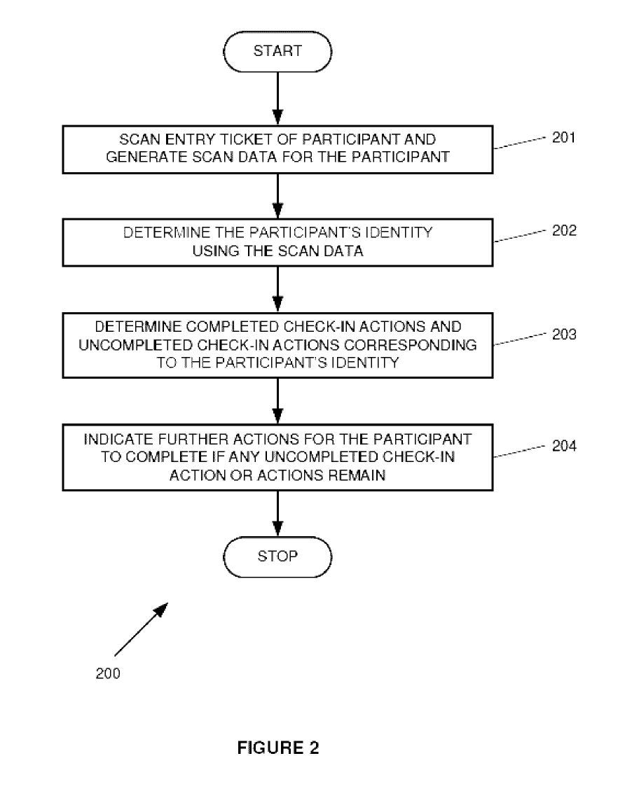

FIG. 2 is a flowchart 200 of a competitive event check-in method. In step 201, a check-in device scans a check-in pass 500 of a participant and generates scan data for the participant. The scanning captures some or all of the information contained within the check-in pass 500. The cheek-in pass 500 can include a one-dimensional or two-dimensional code that stores data.

In step 202, the check-in device determines the participant identity using the scan data. The check-in device in some examples communicates the scan data to an external device, network, or system in order to obtain the participant identity. The cheek-in device is configured to communicate with one or more external networks or systems and determine the participant identity from the scan data by consulting external data storage.

In step 203, the check-in device determines completed check-in actions and uncompleted check-in actions corresponding to the participant identity. The check-in device in some examples receives the completed check-in actions and/or the uncompleted check-in actions in response to communicating the scan data to an external device, network, or system. The check-in device is configured to communicate with, one or more external networks or systems and determine one or both of the completed check-in actions and the uncompleted check-in actions by consulting the external data storage.

In step 204, the cheek-in device indicates further actions for the participant to complete if any uncompleted check-in action or actions remain. Consequently, the participant can complete any uncompleted check-in action or actions in order to complete the cheek-in process. In some examples, the check-in device is configured to determine pre-event preparation of the participant based on stored participant information and generate an annotated cheek-in pass 500 for the participant based on the pre-event preparation. In some examples, the check-in device is configured to determine pre-event preparation of the participant based on stored participant information, wherein the pre-event preparation criterion comprises one or more of a verified document upload, a pre-payment level or a participant rank.

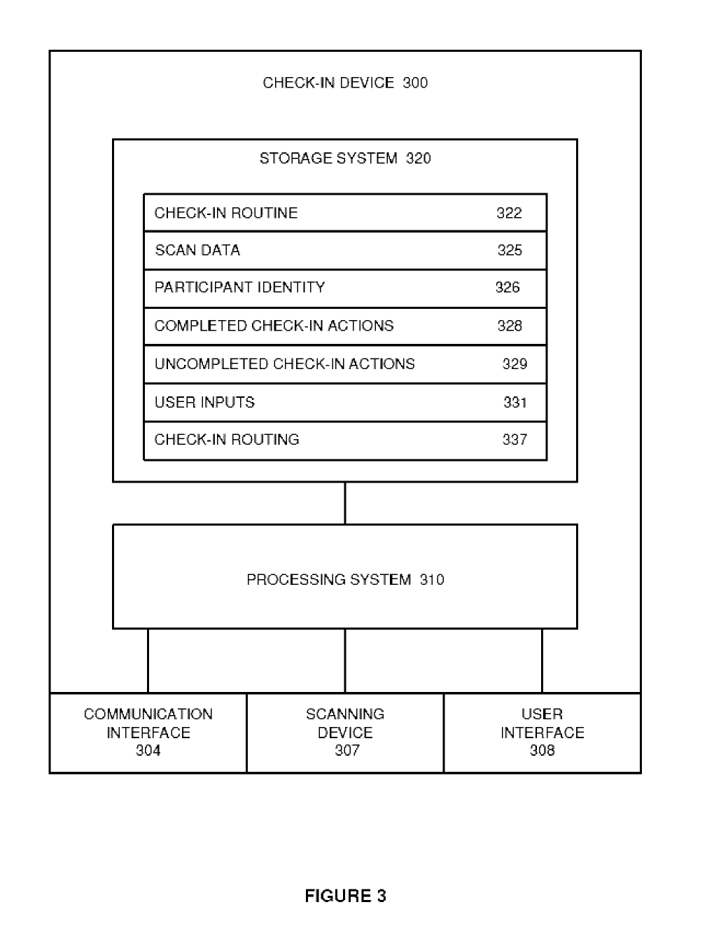

FIG. 3 shows a check-in device 300 in another example. The check-in device 300 can be similar to or different from the check-in device 100 of FIG. 1. The check-in device 300 in this example includes a communication interface 304, a scanning device 307, a user interface 308, a processing system 310, and a storage system 320, as previously discussed. The storage system 320 stores a check-in routine 322, scan data 325, a participant identity 326, one or more completed check-in actions 328, and one or more uncompleted check-in actions 329, as previously discussed. In addition, the storage system 320 stores one or more user inputs 331 and a check-in routing 337.

The user inputs 331 comprise inputs received from the user of the check-in device 300. The user inputs 331 in some examples comprise Inputs of one or more uncompleted cheek-in actions, inputs of one or more documents or items, and/or the selection of a generation, of the check-in routing 337.

The check-in routing 337 comprises a routing for the participant to follow in order to complete a check-in process. The check-in muting 337 comprises a check-in routing generated for a participant and corresponding to a particular participant identity 326. The check-in routing 337 can indicate a sequence of actions. The check-in routing 337 can indicate a prioritized sequence of actions. The cheek-in routing 337 can indicate an optimized sequence of actions.

The check-in routing 337 in some examples comprises an optimal routing that substantially minimizes a geographical distance required for the participant to complete the check-in process. The check-in routing 337 in some examples comprises an optimal routing that substantially minimizes a time required for the participant to complete the check-in process. The check-in routing 337 in some examples comprises an optimal routing that prioritizes check-in steps of the check-in process. The check-in routing 337 in some examples comprises an optimal routing that substantially simplifies the check-in process for the participant.

When executed by the processing system 310, the check-in routine 322 directs the check-in device 300 to scan a check-in pass 500 of a participant and generate the scan data 325 for the participant, determine the participant identity 326 using the scan data 325, determine completed check-in actions 328 and uncompleted check-in actions 329 corresponding to the participant identity 326, indicate further actions for the participant to complete if any uncompleted check-in action or actions 329 remain, generate and present an expedited check-in routing 337 to expedite performance of the uncompleted check-in actions 329, and receive user inputs 331 to perform some, none, or all of the uncompleted check-in actions 329.

The presenting of the check-in routing 337 can be in any suitable form. The presenting can comprise a visual display or presentation of the check-in routing 337. The presenting can comprise an audio presentation of the check-in routing 337. However, other suitable forms of information presentation can be employed.

In some embodiments, the processing system 110 is further configured to generate and present the expedited check-in routing 337 based on the completed check-in actions 328, wherein the check-in pass 500 of the participant includes expedited routing in advance of the competitive event based on a level of completion of cheek-in actions.

In some embodiments, the check-in device 300 further comprises a communication interface 304 configured to communicate with one or more external networks or systems, with the processing system 110 determining the participant's identity 326 from the scan data 325 by consulting an external data storage using the communication interlace 304 and with the processing system 110 determining one or both of the completed check-in actions 328 and the uncompleted check-in actions 329 by consulting an external data storage using the communication interface 304.

In some embodiments, the processing system 110 is further configured to determine pre-event preparation of the participant based on stored participant information and generate an annotated check-in pass for the participant based on the pre-event preparation.

In some embodiments, the processing system 110 is further configured to determine pre-event preparation of the participant based on stored participant information, wherein the pre-event preparation criterion comprises one or more of verified document uploads, a pre-payment level, or a participant rank.

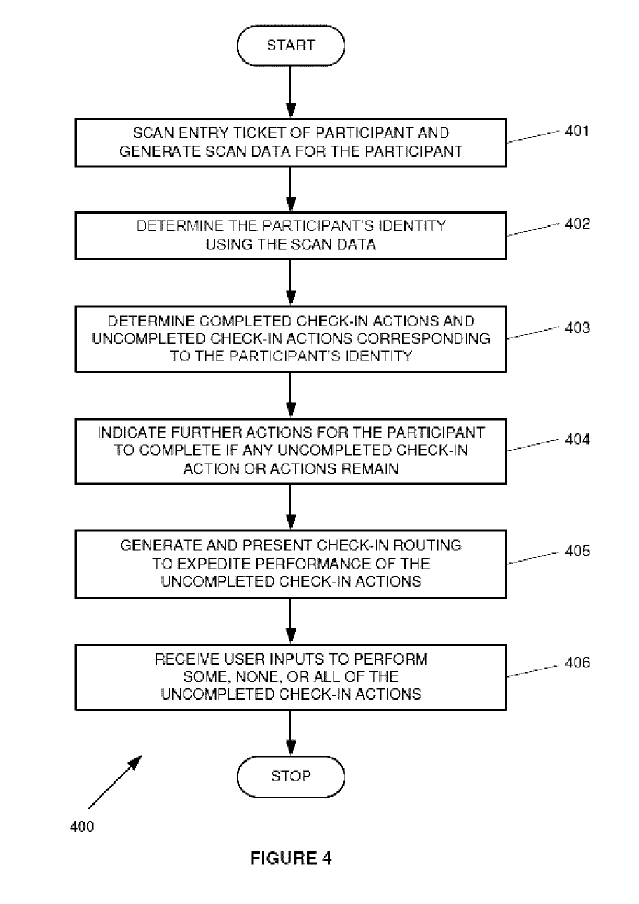

FIG. 4 is a flowchart 400 of a competitive event check-in method. In step 401, a cheek-in device scans a check-in pass 500 of a participant and generates scan data for the participant. The scanning captures some or all of the information contained within the check-in pass 500. The check-in pass 500 can include a one-dimensional or two-dimensional code that stores data.

In step 402, the check-in device determines the participant identity using the scan data. The cheek-in device in some examples communicates the scan data to an external device, network, or system in order to obtain the participant identity. The check-in device is configured to communicate with one or more external networks or systems and determine the participant identity from the scan data by consulting external data storage.

In step 403, the check-in device determines completed check-in actions and uncompleted check-in actions corresponding to the participant identity. The check-in device in some examples receives the completed check-in actions and the uncompleted check-in actions in response to communicating the scan data to an external device, network, or system. The cheek-in device is configured to communicate with one or more external networks or systems and determine one or both of the completed check-in actions and the uncompleted check-in actions by consulting the external data storage.

In step 404, the check-in device indicates further actions for the participant to complete if any uncompleted check-in action or actions remain. Consequently, the participant can complete any uncompleted check-in action or actions in order to complete the check-in process. In some examples, the check-in device is configured to determine pre-event preparation ox the participant based on stored participant information and generate an annotated check-in pass 500 for the participant based on the pre-event preparation. In some examples, the check-in device is configured to determine pre-event preparation of the participant based on stored participant information, wherein the pre-event preparation criterion comprises one or more of verified document uploads, a pre-payment level, or a participant rank.

In step 405, the check-in device generates and presents a check-in routing to expedite performance of the uncompleted check-in actions. The presenting can be in any suitable form. The presenting in some examples comprises generating one or more of a visual or audio presentation to a user of the check-in device, a participant and/or others.

The check-in routing can indicate a sequence of actions, as previously discussed. The check-in routing can indicate a prioritized sequence of actions, as previously discussed. The check-in routing in some examples comprises an optimized routing, as previously discussed.

In step 406, the check-in device receives user inputs to perform some, none, or all of the uncompleted check-in actions. The user inputs are received from the user or operator of the check-in device (such as a check-in official of a competitive event), the participant, or others. The user inputs in some examples comprise inputs of one or more uncompleted check-in actions, inputs of one or more documents or items, and/or selection of the generation of the check-in routing. When the user inputs select the generation of the check-in routing, subsequent user inputs can comprise actions taken to satisfy uncompleted check-in actions, for example.

FIG. 5 shows a check-in pass 500 in one example. The check-in pass 500 is used for admission into a competitive event or similar event. The check-in pass 500 can comprise a paper (or similar) ticket with information printed on one or both sides, for example.

The check-in pass 500 in the example shown includes a left portion 502 and a right portion 504. The left portion 502 of the check-in pass 500 in the FIG. supports rapid identification of a participant and the participant's status. The left portion 502 of the check-in pass 500 further characterizes the participant's pre-event preparation. The left portion 502 includes a pre-event preparation field 512, a participant type field 534, a skill level field 532, a participant name field 530, a requirements field 536, an event location field 556, an event name field 554, a venue location field 552, and an event date field 550. The right portion 504 includes an event date field 560, an event name field 564, a participant name field 540, a participant type field 544, a skill level field 542, an age field 548, a pre-event preparation field 510, and a scannable element 520.

The pre-event preparation field 512/510 contains pre-event preparation information, such as event registration requirements that have been satisfied by the participant. The participant name field 530/540 contains name information for the participant. The skill level field 532/542 contains skill level information for the participant. The participant type field 534/544 contains event type information for the participant The requirements field 536 contains event registration requirements information for the participant. The event date field 550/560 contains event date information for the event. The venue location field 552 contains venue location information for the event, such as where the event features more than one venue locations. The event name field 554/564 contains event name information for the event. The event location field 556 contains event location information for the event. The age field 548 contains age information for the participant. The scannable element 520 contains scannable information that can be optically, magnetically, or electromagnetically scanned, for example.

The scannable element 520 can be scanned by a reader, such as an optical reader, magnetic reader, or other suitable reader device, wherein cheek-in pass Information contained in the scannable element 520 can be read into a processor device and processed. The scannable element 520 can comprise a one-dimensional optical code, such as a one-dimensional bar code, in some examples. Alternatively, the check-in pass information can comprise a two-dimensional optical code, such as a Quick Response (QR) code, in other examples.

For convenience, much information included in the left portion 502 is repeated in the right portion 504. The right portion 504 in some embodiments can be torn, cut, or otherwise separated from the left portion 502. The pre-event preparation fields 510 and 512 are used for determining check-in queuing. Participant information comprises the participant name fields 530 and 540, the skill level fields 532 and 542, the participant type fields 534 and 544, and the age field 548. The requirements field 536 identifies on-site requirements, such as whether a weigh-in is required. Event information comprises the event date fields 550 and 560, a venue location field 552, the event name fields 554 and 564, and the event location field 556. The scannable element 520 is scanned to eliminate manual look-up of the participant.

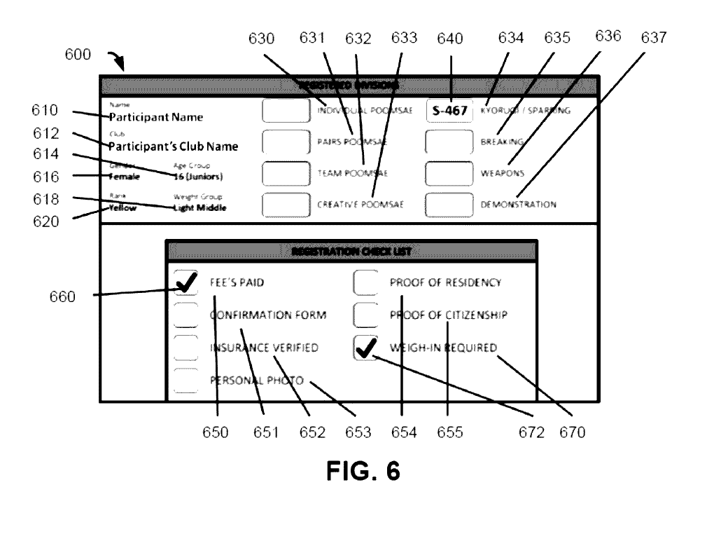

FIG. 6 shows a second side 600 of the check-in pass 500. The second side 600 of the check-in pass 500 confirms the events for which the participant has registered. In addition, the second side 600 identities the preparation items for the participant that are complete or that are needed. The preparation items in the embodiment shown are presented in a check-list format. Key participant information is displayed, including a participant name 610, participant's club name 612, age 614, gender 616, weight class 618, and skill level 620.

The potential events 630-637 are listed. The event(s) for which the participant is registered are filled in 640.

The relevant pre-even. preparation items 650-655 are identified. The completed items are checked 660 in the embodiment shown. It should be understood that the completed items can be indicated in other ways, such as an X, coloring/shading or other filling-in methods. Any missing items are left un-checked. Special on-site requirements) are also listed 670 and checked 672 if applicable.

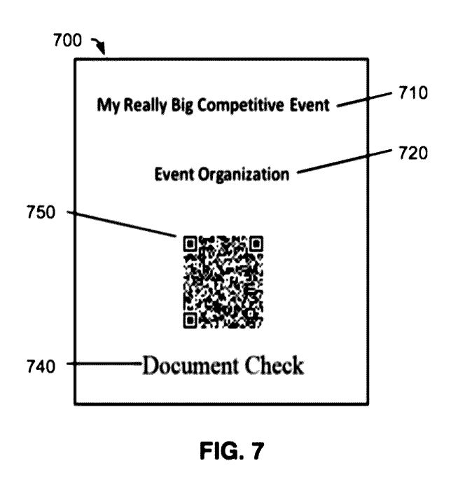

FIG. 7 shows a sample single-function activity code 700 that can be displayed at a competitive event and comprises a portion or step of a check-in process. The single-function activity code 700 initiates the process for the stated activity, such as a document cheek 740. It should be understood that other single-function activity codes 700 can be generated and displayed for other check-in steps or processes. The activity code is tied to a specific event 720, whose logo (not shown) and backing entity 710 are identified.

The scannable code 750 embeds a link to a processing function or website. The scannable code 750 in some embodiments further includes appropriate parameters, such as the tournament identifier (i.e., the event name field 554/564 of FIG. 5, for example) and the single-function activity code 700.

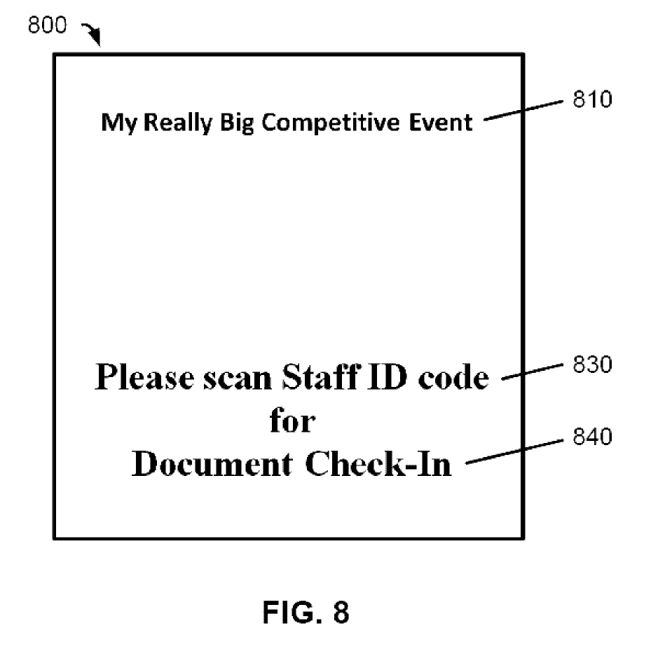

FIG. 8 shows an administrative user validation request 800 that is presented to an administrative user, such as event staffer event registration staff for example. After the single-function activity code 700 of FIG. 7 has been scanned, and processed, the system responds with a request to validate the administrative user 800. This is tied to a specific event 810. The page Indicates a need to scan the administrative user's “staff ID” code 830 and affirms the function of interest, such as a document check-in 840, for example.

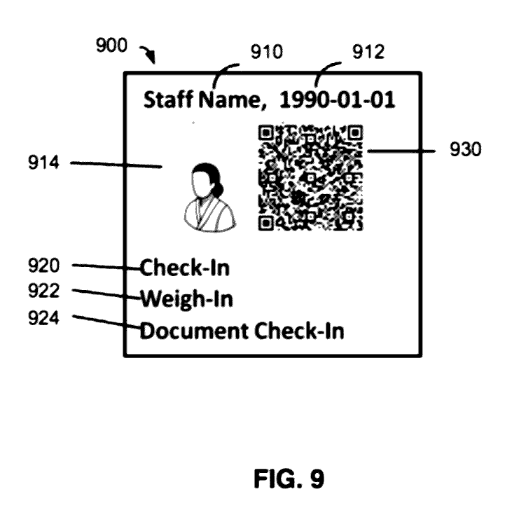

FIG. 9 shows a sample staff credential 900. The sample staff credential 900 enables authorization of a single-function activity. Some administrative user information is provided on the staff credential 900, such as name 910, birthdate 912, and administrative user photo 914. The single-function activities for which the user is authorized are enumerated 920, 922, and 924.

The scannable code 930 embeds a link to a processing function or website. The scannable code 930 can include appropriate parameters, such as the tournament identifier and the user identification code. The printed version is scannable by a QR code reader, while the version presented on an electronic display screen embeds the same link, such that the scannable code 930 may be clicked-on. directly.

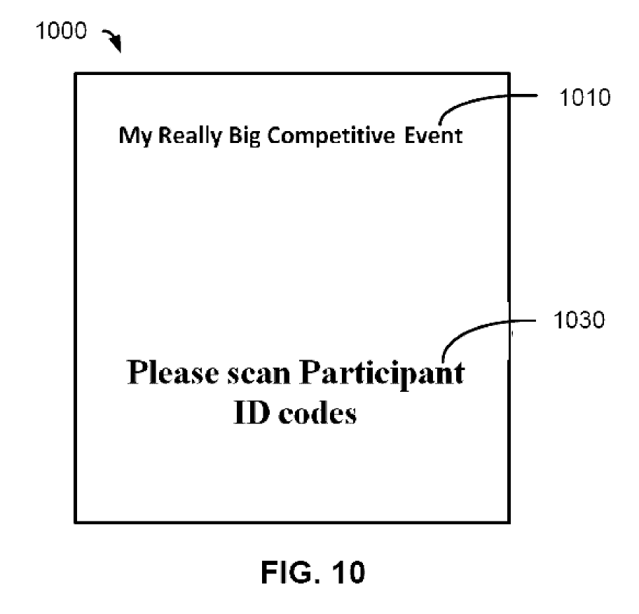

FIG. 10 shows a participant codes scanning request 1000. The participant codes scanning request 1000 in some embodiments is displayed on an electronic display screen or other display tor displaying check-in process steps and results. After the administrative user has been validated for the given single-function activity code, the system responds with the participant

codes scanning request 1000.

The display of the participant codes scanning request 1000 is tied to a specific event 1010, whose logo (not shown) can be presented. The page indicates a need to scan the participant code 1030.

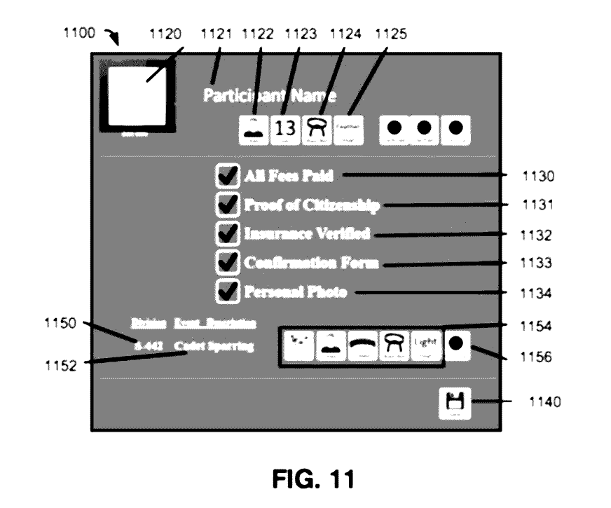

FIG. 11 shows a sample single-function document check activity code 1100. The document check activity code 1100 gives an administrative user the ability to verify and check-off the presence of required documents. Participant information is shown, consisting of a participant photo 1120, name 1121, gender 1122, age 1123, skill level 1124, and weight class 1125. Documents or other pre-requisites are listed 1130-1134 and checked once verified. A button/icon 1140, or equivalent mechanism, can be selected by the administrative user in order to save the information to a server or other storage.

All events into which the participant has registered are displayed (only one is shown in the sample) show a division ID 1150, an event classification 1152, event details 1154, and when appropriate, an indicator that the participant has weighted-in within the weight class limits 1156.

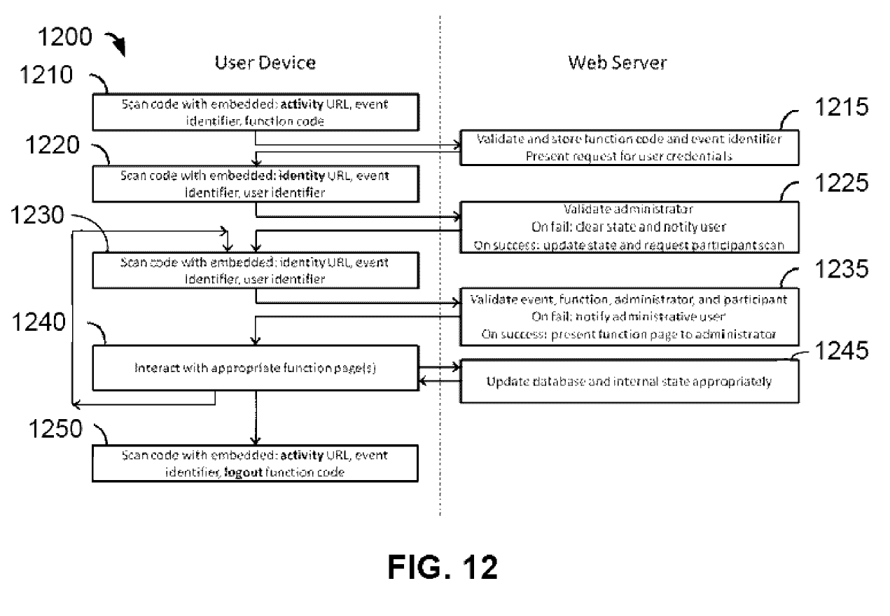

FIG. 12 shows a general flow control for a single-activity function 1200. At step 1210, the single-activity function 1200 starts with a user or participant scanning the code for the desired function. The code embeds the activity URL, the event identifier, and the function code. The same information can be embedded in a clickable link or can be manually entered by the user or participant.

At step 1215, the information is sent by the scanning device or computer to a web server of the event for processing (at the activity URL). The processing validates the event and the desired function. If the processing is successful, the event and function are stored as state information for the given connection and the user or participant is requested to scan/enter their code to ensure they are authorized for the given function.

At step 1220, the administrative user scans the code on their credentials. This code embeds the identity URL, the event identifier, and the user identity.

At step 1225. the information is sent to the web server for processing (at the identity URL). The processing validates the user is authorized for the desired function. On failure, the would-be administrative user is logged out and internal state flags are cleared. If successful, the administrative user is notified to start scanning user codes to perform the desired function for the scanned users.

At step 1230, the administrative user scans the code on participant credentials. This code embeds the identity URL, the event identifier, and foe user identity.

At step 1235. the Information Is sent to the web server for processing (at the identity URL). The processing validates the event, the function, the authorization of the connection, and the user.

At step 1240, the appropriate function pages are presented to the administrative user who interacts with the pages, viewing or changing the state of the function pages.

At step 1245, the function pages are saved back to the server. When the administrative user is done with one participant, they may then scan the code for the next participant, repeating until done.

At step 1250, once done, the user or participant may scan the code for the logout function.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

1. A check-in device configured to perform check-ins for a competitive event, comprising:
a scanner configured to scan a check-in pass of a participant and. generate scan data for the participant;
a processing system configured to determine the participant's identity using the scan data, determine completed check-in actions and uncompleted check-in actions corresponding to the participant's identity, and Indicate further actions for the participant to complete if any uncompleted check-in action or actions remain.

2. The check-in device of claim 1, with the processing system further configured to generate and present a check-in routing based on the uncompleted check-in actions to expedite performance of the uncompleted check-in actions.

3. The cheek-in device of claim 1, with the processing system farther configured to receive user inputs to perform some, none, or all of the uncompleted check-in actions.

4. The check-in device of claim 1, with the processing system further configured to generate and present an expedited check-in routing based on the completed, check-in actions, wherein the check-in pass of the participant, includes expedited routing in. advance of the competitive event based on a level of completion of check-in actions.

5. The check-in device of claim 1, further comprising a communication Interface configured to communicate with one or more external networks or systems:
with the processing system, determining the participant's identity from the scan data by consulting an external data storage using the communication interface; and
with the processing system determining one or both of the completed check-in actions and the uncompleted check-in actions by consulting an external data storage using the communication interface.

6. The check-in device of claim 1, with the processing system further configured to determine pre-event preparation of the participant based on stored participant information, and generate an annotated check-in pass for the. participant based on the pre-event preparation.

7. The check-in device of claim 1, with the processing system further configured to determine pre-event preparation of the participant based on stored participant information, wherein the pre-event preparation criterion comprises one or more of verified document uploads, a pre-payment level, or a participant rank.

8. A check-in device configured to perform check-ins for a competitive event, comprising:
a scanner configured to scan a check-in pass of a participant and generate scan data for the participant;
a processing system configured to determine the participant's identity using the scan data, determine completed check-in actions and uncompleted check-in actions corresponding to the participant's identity, indicate further actions for the participant to complete if any uncompleted check-in action or actions remain, and generate and present an expedited check-in routing based on the completed check-in actions, wherein the check-in pass of the participant Includes expedited routing in advance of the competitive event based on a level of completion of check-in actions.

9. The check-in device of claim 8, with the processing system further configured to generate and present a check-in routing based on the uncompleted check-in actions to expedite performance of the uncompleted check-in actions.

10. The check-in device of claim 8, with the processing system further configured to receive user Inputs to perform some, none, or all of the uncompleted check-in actions.

11. The check-in device of claim 8, further comprising a communication interface configured to communicate with one or more external networks or systems:
with the processing system determining the participants Identity from the scan data by consulting an external data storage using the communication interlace; and
with the processing system determining one or both of the completed check-in actions and the uncompleted check-in actions by consulting an external data storage using the communication interface.

12. The check-in device of claim 8, with the processing system further configured to determine pre-event preparation of the participant based on stored participant information, and generate an annotated check-in pass for the participant based on the pre-event preparation.

13. The check-in device-of claim 8, with the processing system further configured to determine pre-event preparation of the participant based on stored participant information, wherein the pre-event preparation criterion comprises one or more of verified document uploads, a pre-payment level, or a participant rank.

14. A competitive event-check-in method, comprising:
in a check-in device, scanning a check-in pass of a participant and generating scan data for the participant;
in the check-in device, determining the participant's identity using the scan data;
in the check-in device, determining completed check-in actions and uncompleted cheek-in actions corresponding to the participant's identity; and
in the check-in device, indicating further actions for the participant to complete if any uncompleted cheek-in action or actions remain.

15. The method of claim 14, with the method further comprising the cheek-in device generating and presenting a check-in routing based on the uncompleted check-in actions to expedite performance of the uncompleted check-in actions.

16. The method of claim 14, with the method further comprising, in the check-in device, receiving user inputs to perform some, none, or all of the uncompleted check-in actions.

17. The method of claim 14, with the processing system further configured to generate and present an expedited check-in routing based on the completed check-in actions, wherein the check-in pass of the participant includes expedited routing in advance of the competitive event based on a level of completion of check-in actions.

18. The method of claim 14. with the method further comprising:
in the check-in device, communicating with one or more external networks or systems and determining the participant's identity from the scan data by consulting an external data storage using the communication interface; and
in the check-in device, communicating with one or more external networks or systems and determining one or both of the completed check-in actions and the uncompleted check-in actions by consulting an external data storage using the communication Interface.

19. The method of claim 14, with the method further comprising:
in the check-in device, determining pre-event preparation of the participant based on stored participant information; and
in the check-in device, generating an annotated check-in pass for the participant based on the pre-event preparation.

20. The method of claim 14, with the method further comprising, in the check-in device, determining pre-event preparation of the participant based, on stored participant information, wherein the pre-event preparation criterion comprises one or more of verified document uploads, a pre-payment level, or a participant rank.
